(19) United States
(12) Patent Application Publication
(10) Pub. No.: US 2017/0214026 A1
(43) Pub. Date: Jul. 27, 2017

(54) FLEXIBLE BATTERY

(71) Applicant: Panasonic Intellectual Property Management Co., Ltd., Osaka (JP)

(72) Inventors: TOMOHIRO UEDA, Osaka (JP); YUYA ASANO, Osaka (JP); YOKO SANO, Osaka (JP)

(21) Appl. No.: 15/326,827

(22) PCT Filed: Aug. 17, 2015
(86) PCT No.: PCT/JP2015/004072

§ 371 Date: Jan. 17, 2017

(30) Foreign Application Priority Data
Sep. 29, 2014 (JP) 2014-198738

(51) Int. Cl. H01M 2/26; H01M 10/0585

(52) U.S. Cl. CPC H01M 2/26; H01M 10/0585; H01M 2220/30

(57) ABSTRACT

A flexible battery including a sheet-like electrode group including first electrode, second electrode, and an electrolyte layer; electrode lead terminals; and a housing. First ends of the electrode lead terminals are connected to the electrodes on a side S1t side of the electrode group. Each electrode includes a current collector and an active material layer. First active material layer (A1) on one main surface of first electrode has a non-facing portion (Pt) with respect to second active material layer (A2) on one main surface of second electrode on the S1t side, and a non-facing portion (Pn) with respect to second active material layer (A2) on one main surface of second electrode on the opposite side to the S1t. The shortest length LAt of the non-facing portion (Pt) and the shortest length LAn of non-facing portion (Pn) satisfy LAt<LAn in the horizontal state.

### TECHNICAL FIELD

The present invention relates to a bendable flexible battery including an electrode group and a housing that houses the electrode group.

### BACKGROUND ART

In recent years, there has been progress in portable electronic devices that are compact in design, for example, portable telephones and hearing aids. Furthermore, devices that operate in contact with a living body are increasing. For example, development is made for a biological information signal sending device capable of measuring and monitoring biological information such as body temperature, blood pressure, and pulse, and automatically sending such biological information to hospitals and the like. Moreover, development is also being made for a biological wearable device capable of supplying medicine, etc. through the outer skin of a living body by application of electric potential.

Under such circumstances, there is a demand for thin and flexible batteries that supply power. Examples of thin batteries that have been developed to date include paper batteries, flat batteries, and plate batteries. However, such batteries are excellent in strength, but there is a problem of having difficulty in making the batteries flexible.

Therefore, development of a technology using thin and flexible laminated sheet for a housing of a battery has been made (see, for example, PTL 1). Such a flexible battery includes an electrode group having a structure in which a flat-shaped positive electrode and negative electrode are stacked with a separator interposed therebetween; and in which a part of a positive electrode lead connected to the positive electrode and a part of a negative electrode lead connected to the negative electrode are allowed to extend from the housing to the outside, respectively. Exposed portions of the leads are used as a positive electrode terminal and a negative electrode terminal, respectively.

### CITATION LIST

### Patent Literature

PTL 1; Japanese Patent Application Unexamined Publication No. 2008-71732

### SUMMARY OF THE INVENTION

### Technical Problem

Such flexible batteries are expected to be used in various modes, for example, charge and discharge in a bending state, charge and discharge in a horizontal state, or charge in a horizontal state and discharge in a bending state. Flexible batteries are required to keep reliability as a battery regardless of use modes. However, as in PTL 1, even when the housing or the electrode group are flexible, when the battery is charged or discharged repeatedly in a bending state, battery performance may be largely deteriorated. This is considered to be because, in a bending state, a portion in which the positive electrode and the negative electrode do not face each other is generated.

Usually, in the secondary battery, in order to prevent precipitation of dendrites in a negative electrode, a negative electrode is made to be larger than a positive electrode. However, even when such an electrode group is used, when the battery is bent, a portion in which the end portion of the negative electrode and the end portion of the positive electrode cannot face each other may be generated. For example, when an electrode group (negative electrode/positive electrode/negative electrode), in which a positive electrode and two negative electrodes are stacked to each other with the positive electrode interposed between the negative electrodes, is bent, the end portion of the negative electrode and the end portion of the positive electrode may be displaced from each other because the curvature of the negative electrode and the curvature of the positive electrode are different from each other.

FIG. 7 shows electrode group 11 obtained by stacking two same-sized rectangular negative electrodes 200 to each other with rectangular positive electrode 300 and separator 400 interposed therebetween. Herein, rectangular positive electrode 300 has smaller than negative electrodes 200. Each negative electrode 200 includes negative electrode current collector 500 and negative electrode active material layer 200A on one surface of negative electrode current collector 500. Positive electrode 300 includes positive electrode current collector 600 and positive electrode active material layers 300A on both surfaces of positive electrode current collector 600. Furthermore, in electrode group 11, on one side S1ₜ, electrode lead terminals 30 and 40 are jointed to portions in which active material layers of negative electrode 200 and positive electrode 300 are not formed (for example, lead tabs), respectively. A lead tab of negative electrode 200 to which electrode lead terminal 30 is not joined is welded and electrically jointed to the lead tab to which electrode lead terminal 30 is joined. FIG. 7, for the sake of convenience, does not show a state in which the lead tabs are welded to each other.

Positive electrode active material layer 300A is disposed such that the entire surface thereof faces negative electrode active material layer 200A of each negative electrodes 200. Specifically, negative electrode active material layer 200A at S1ₜ side has non-facing portion Pt with respect to positive electrode active material layer 300A, and negative electrode active material layer 200A at side (S1ₙ) opposite to S1ₜ has non-facing portion Pₙ with respect to positive electrode active material layer 300A. In view of suppressing of deterioration of battery performance, positive electrode active material layer 300A is disposed in the center of negative electrode active material layer 200A such that non-facing portions Pₜ and Pₙ have substantially the same size.

When electrode group 11 is in a horizontal state (see FIG. 7(a)), the entire surface of positive electrode active material layer 300A faces negative electrode active material layer 200A. However, when the side to which negative electrode lead terminal 30 is joined (in the vicinity of S1ₜ) is fixed, and the S1ₙ side is pulled downward in the drawing sheet so as to bend electrode group 11 (see, FIG. 7(b)), end portions of the electrodes are displaced at the S1ₙ side and non-facing portion Pₙ is lost. As a result, not entire surface of positive electrode active material layer 300A faces negative electrode active material layer 200A below. In addition, non-facing portion 300N of positive electrode active material, which does not face negative electrode active material layer 200A, is generated. This is because the electrode on the upper side (outer side of the bending) and the electrode on the lower side (inner side of the bending) in the drawing sheet have different curvatures. Therefore, precipitation of dendrites easily occurs in the negative electrode, and battery performance is easily deteriorated. Note here that non-facing portion Pₜ at the S1ₜ side can be maintained.

The present invention has an object to provide a flexible battery in which active material layers are disposed such that an active material layer of a positive electrode and an active material layer of a negative electrode face each other in a bending state, and thereby performance is not easily deteriorated even when charge and discharge are repeated in the bending state.

### Solution to Problem

A flexible battery in accordance with one aspect of the present invention includes a sheet-like electrode group including first electrode D1, second electrode D2, and an electrolyte layer interposed between the first electrode D1 and the second electrode D2; a pair of electrode lead terminals connected to the first electrode D1 and the second electrode D2, respectively; and a housing for housing the electrode group. The first electrode D1 and the second electrode D2 are all rectangular. First ends of the electrode lead terminals are connected to first electrode D1 and the second electrode D2, respectively, on a side S1ₜ side of the electrode group. The first electrode D1 includes a first current collector, and a first active material layer A1 formed on a surface of the first current collector. The second electrode D2 includes a second current collector, and a second active material layer A2 formed on a surface of the second current collector. The first active material layer A1 on at least one main surface of the first electrode D1 has a non-facing portion Pt with respect to the second active material layer A2 on one surface of the second electrode D2 at the S1ₜ side, and a non-facing portion Pₙ with respect to the second active material layer A2 on one main surface of the second electrode D2 at an opposite side to the S1ₜ. The shortest length LAₜ of the non-facing portion Pₜ in a direction perpendicular to the S1ₜ and a shortest length LAₙ of the non-facing portion Pₙ in a direction perpendicular to the S1ₜ satisfy LAₜ<LAₙ in a horizontal state.

### Advantageous Effect of Invention

According to the present invention, it is possible to obtain a flexible battery in which performance is not easily deteriorated even when charge and discharge are repeated in a bending state. Thus, even when a flexible battery is mounted to a device that requires flexibility, the device can be used for a long time.

### BRIEF DESCRIPTION OF THE DRAWINGS

FIG. 1 is a top view of a flexible battery including an electrode group in accordance with one exemplary embodiment of the present invention.

FIG. 2(a) is a sectional view taken on line X-X of an electrode group of a flexible battery shown in FIG. 1 in a horizontal state in accordance with a first exemplary embodiment; and FIG. 2(b) is a sectional view thereof in a bending state.

FIG. 3 is a view for illustrating length of a non-facing portion.

FIG. 4 is a sectional view of an electrode group taken on line X-X of a flexible battery shown in FIG. 1 in accordance with a second exemplary embodiment.

FIG. 5 is a sectional view of an electrode group taken on line X-X of a flexible battery shown in FIG. 1 in accordance with a third exemplary embodiment.

FIG. 6 is a view for illustrating a bending test method.

FIG. 7(a) is a sectional view of an electrode group of a flexible battery in a horizontal state in accordance with a conventional technology, and FIG. 7(b) is a sectional view thereof in a bending state.

### DESCRIPTION OF EMBODIMENTS

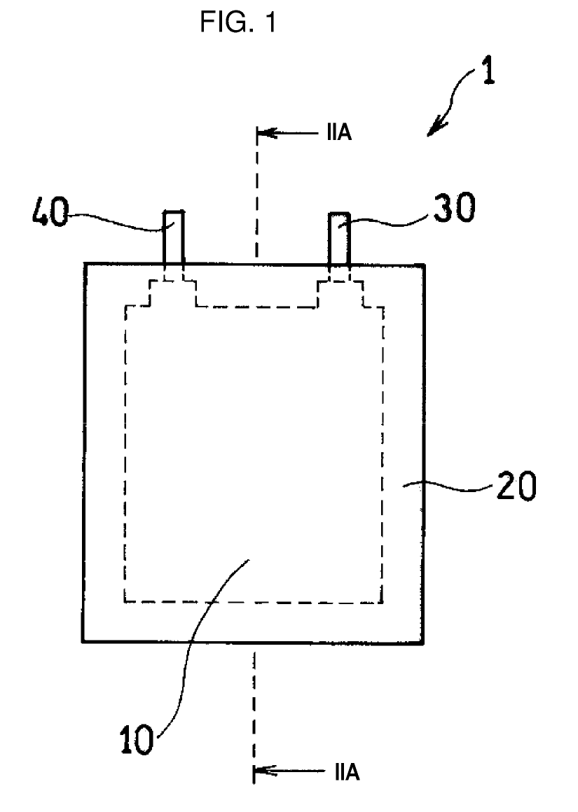

A flexible battery of the present invention includes sheet-like electrode group 10 including a first electrode, a second electrode, and an electrolyte layer interposed between the first electrode and the second electrode; a pair of electrode lead terminals (first electrode lead terminal 30 and second electrode lead terminal 40) connected to the first electrode and the second electrode, respectively; and housing 20 for housing the electrode group (see FIG. 1). The first electrode and the second electrode are rectangular, respectively, and each includes a current collector, and a first active material layer or a second active material layer formed on a part of the surface of the current collector. The electrolyte layer may include a non-aqueous electrolyte and a porous sheet for holding the non-aqueous electrolyte. In this case, the porous sheet may be swollen with a non-aqueous electrolyte.

The electrode group may have a substantially rectangular shape. The substantially rectangular shape includes, for example, a square, a rectangle having at least one round corner, a trapezoid or parallelogram having an interior angle of near 90° (for example, about 80° to 100°), or the like. From the viewpoint of productivity, it is preferable that the electrode group and the first and second electrodes constituting the electrode group are rectangular seen from one of the main surfaces.

The length ratio of the long side to the short side of the electrode group may satisfy long side:short side=1:1 to 8:1. According to the present invention, even when an electrode group having such a large length ratio of the long side to the short side is bent in the direction in which the long side is bent, deterioration of battery performance can be suppressed. Furthermore, the first electrode and the second electrode may have a rectangular or substantially rectangular main part on which the active material layer is to be formed, and lead tabs which extends from the main part and to which lead wires are joined.

When the number of the first electrodes and/or second electrodes to be stacked is too large, the thickness of the electrode group becomes large. This may decrease flexibility. Therefore, each of the number of the first electrodes and second electrodes to be stacked is 8 layers or less, and more preferably 5 layers or less. Furthermore, the thickness of the battery is preferably 2 mm or less, more preferably in a range from about 0.3 to 1.5 mm, and particularly preferably in a range from about 0.4 to 1.5 mm

### First Exemplary Embodiment

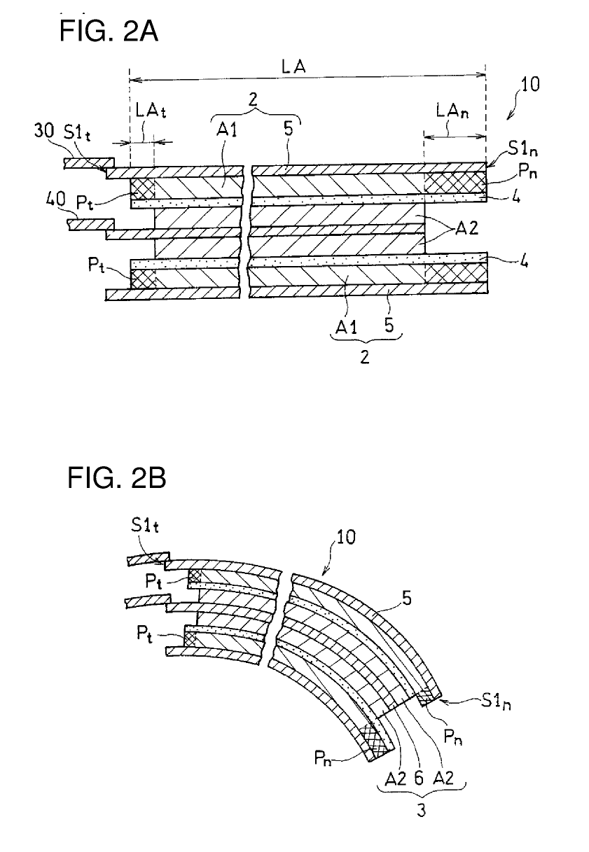

Hereinafter, an electrode group of a first exemplary embodiment is described with reference to FIGS. 2(a) and (b).

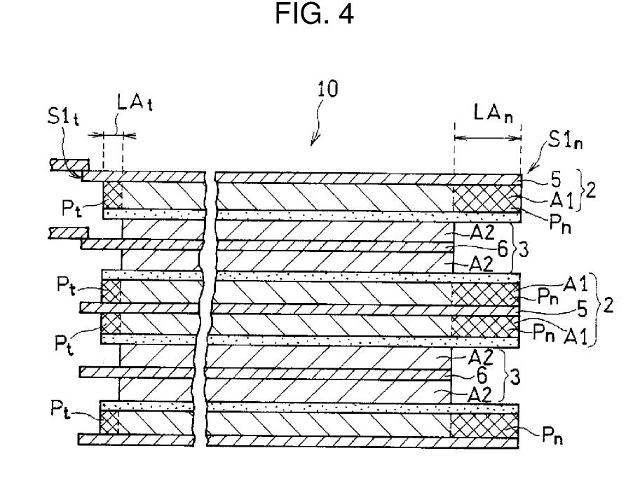

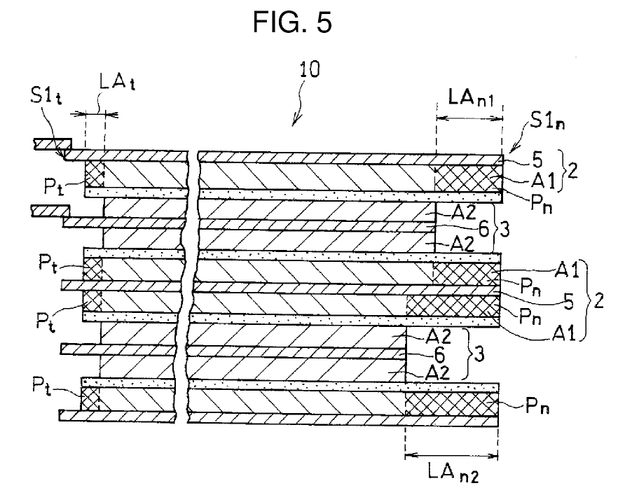

First electrode 2 (D1) constituting electrode group 10 includes first current collector 5 and first active material layer A1 on one surface of first current collector 5. Second electrode 3 (D2) includes second current collector 6 and second active material layers A2 on both surfaces of second current collector 6. To a part (for example, a lead tab) of electrode group 10 in which active material layers of first electrode D1 and second electrode D2 are not provided on a side S1ₜ side of electrode group 10, electrode lead terminals 30 and 40 are joined, respectively. A lead tab of first electrode D1 to which electrode lead terminal 30 is not joined is electrically joined by, for example, welding, to the lead tab to which electrode lead terminal 30 is joined. Similarly, when a plurality of second electrodes D2 are stacked, lead tabs are electrically joined to each other by, for example, welding. For the sake of convenience, FIG. 2 and below-mentioned FIGS. 4 and 5 do not show a state in which lead tabs are welded to each other.

Second active material layer A2 is disposed such that entire surfaces of the both surfaces of second active material layer A2 face the adjacent first active material layers A1 of first electrode D1. Specifically, first active material layer A1 on S1ₜ side has non-facing portion Pₜ with respect to second active material layer A2, and first active material layer A1 at the opposite side (S1ₙ) to S1ₜ has non-facing portion Pn with respect to second active material layer A2. Herein, non-facing portions Pt and Pn satisfy LAₜ<LAₙ in a horizontal state shown in FIG. 2(a), wherein LAₜ is the shortest length of the non-facing portion Pₜ in a direction perpendicular to the S1ₜ, and LAₙ is the shortest length of the non-facing portion Pₙ in a direction perpendicular to the S1ₜ.

Non-facing portion P of first active material layer A1 with respect to second active material layer A2 is not particularly limited as long as it is at least disposed on the S1ₜ side and the S1ₙ side of first active material layer A1. For example, non-facing portion P may be disposed along the side perpendicular to the S1ₜ of first active material layer A1.

When first active material layer A1 and second active material layer A2 have positional relation as mentioned above, entire surfaces of second active material layers A2 on both main surfaces of second electrode D2 can face both first active material layers A1 of two first electrodes D1 adjacent to second active material layer A2, not only in the horizontal state shown in FIG. 2(a), but also in the case where electrode group 10 is bent by fixing the vicinity of S1ₜ and pulling the S1ₙ side downward (or upward) in the drawing sheet as shown in FIG. 2(b). Therefore, even when the electrode is charged and discharged repeatedly in a bending state, deterioration of the battery performance can be suppressed.

As shown in FIG. 2(b), in the bending state, non-facing portion Pn in first active material layer A1, which is disposed in the upper part of second electrode D2 that is the outer side of the bending, may be smaller as compared with that in the horizontal state. Therefore, in the bending state, LAₜ<LAₙ is not necessarily required to be satisfied. However, even in the bending state, first active material layer A1 has non-facing portion Pₙ. On the other hand, non-facing portion Pₙ in first active material layer A1, which is disposed in the lower part of second electrode D2 that is the inner side of the bending, may be larger as compared with that in the horizontal state.

Conventionally, as mentioned above, in a secondary battery, in order to prevent precipitation of dendrites in the negative electrode, a negative electrode is made to be larger than a positive electrode and the positive electrode is disposed in the center of the negative electrode. In this case, usually, the length of the non-facing portion is set at about 1/20 of the length in the direction corresponding to the positive electrode active material layer. In this exemplary embodiment, LAₜ may be the same level as the conventional one. For example, LAₜ may be about 1/200 to 1/10 of the length LA₂ in the direction perpendicular to S1ₜ of second active material layer A2.

LAₙ is not particularly limited as long as it is in a range satisfying LAₜ<LAₙ. For example, LAₙ may have at least the size for compensating the displacement generated due to the difference in curvature between first active material layer A1 and second active material layer A2 adjacent thereto, when the electrode group is bent. From this viewpoint, LAₙ can be set as follows.

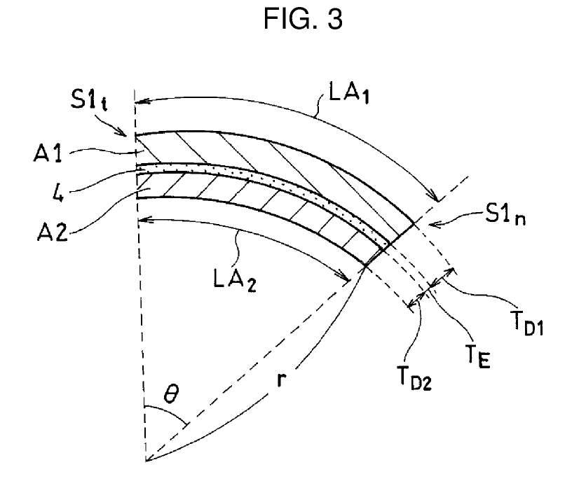

A method for setting LAₙ is described with reference to FIG. 3. FIG. 3 shows first active material layer A1 and a second active material layer adjacent to first active material layer A1. FIG. 3 shows a state in which the vicinity of S1ₜ of electrode group 10 is fixed and the S1ₙ side is pulled downward in the drawing sheet so as to bend electrode group 10. In this case the average radius of curvature of second active material layer A2 is denoted by r, a thickness of first active material layer A1 is denoted by TD₁, a thickness of second active material layer A2 adjacent to first active material layer A1 is denoted by TD₂, and a thickness of electrolyte layer disposed between first active material layer A1 and second active material layer A2 is denoted by T_{E}. Second electrode D2 has second active material layers A2 on both surfaces of second current collector 6, but the above-mentioned TD₂ represents a thickness of second active material layer A2 formed on one surface of second current collector 6.

When electrode group 10 is bent, the radius of curvature may be different depending on places in the electrode group. However, when the average radius of curvature is denoted by r, the electrode group can be regarded to be bent in a perfect circle having a radius of curvature r. Note here that the radius of curvature r is based on the main surface on the inner side of the bending of second active material layer A2. In other words, the main surface on the inner side of the bending of second active material layer A2 can be regarded to draw an arc (length: LA₂) having radius r and central angle θ (rad). The average radius of curvature r can be calculated, for example, by obtaining the minimum radius of curvature and the maximum radius of curvature when the electrode group is bent and calculating the average radius of curvature from the following mathematical formula:

Average value=(Minimum radius of curvature+Maximum radius of curvature)/2.

In order to allow the entire surface of the main surface of second active material layer A2 adjacent to first active material layer A1 to face first active material layer A1 in a bending state, length LA₂ of the main surface on the inner side of the bending of second active material layer A2 is required to be shorter than the length LA₁ of the main surface on the outer side of the bending of first active material layer A1. Therefore, the value obtained by subtracting LA₂ from LA₁ can be regarded as the minimum value of LAₙ. Herein, LA₂ is represented by r×θ (rad) (in other words, θ (rad) is LA₂/r), and LA₁ is represented by (r+TD₁+T_{E} TD₂)×θ.

Accordingly, the minimum value of LAₙ can be calculated based on the following mathematical formula:

$${LA}_{1} - {LA}_{2}$$

$$\begin{matrix}= ( r + {TD}_{1} + {T}_{E} + {TD}_{2} ) \times θ - r \times θ \\ = ( {TD}_{1} + {T}_{E} + {TD}_{2} ) \times θ \\ = ( {TD}_{1} + {T}_{E} + {TD}_{2} ) \times {LA}_{2} / r .\end{matrix}$$

From this, LAₙ can be determined.

For example, when 0.05 mm≦(TD₁+T_{E}+TD₂) 0.5 mm, 20 mm LA₁≦100 mm, and 15 mm≦r≦100 mm are satisfied, and LAₜ is 1/200 to 1/10 of LA₁, the minimum value of LAₙ is 0.1 mm to 3.2 mm. Therefore, it is preferable that LAₙ satisfies 2LAₜ<LAₙ in a horizontal state. Thus, also when the average radius of curvature r satisfies 15 mm≦r≦100 mm, the entire surface of second active material layer A2 easily faces first active material layer A1 adjacent to second active material layer A2. In other words, even when the flexible battery of this exemplary embodiment is used in a state in which it is bent at an average radius of curvature r satisfying 15 mm r 100 mm, performance deterioration does not easily occur.

From the viewpoint of capacity, it is preferable that LAₙ is smaller than 100 times of LAₜ. Similarly, it is preferable that LAₙ is larger than 1/50 of LA₂ and smaller than ⅕ of LA₂. Furthermore, LAₙ may be larger than ½ of TD₁+T_{E}+TD₂, larger than 5 times thereof, and larger than 8 times thereof. When LAₙ is in this range, the entire surface of second active material layer A2 easily faces first active material layer A1 adjacent to second active material layer A2.

### Second Exemplary Embodiment

In this exemplary embodiment, second electrode 3 (D2) and first electrode 2 (D1) are further stacked to the first exemplary embodiment. The electrode group includes D1, D2, D1ₘ, D2, and D1 (see FIG. 4). First electrode D1ₘ in the middle includes first active material layers A1 on both surfaces of first current collector 5. In this case, the above-mentioned TD₁ represents a thickness of first active material layer A1 formed on one surface of first current collector 5. Non-facing portion portions Pₜ and Pₙ are formed on first active material layer A1 of first electrode D1ₘ. Two first electrodes D1 disposed on the outer sides are also provided with non-facing portions Pt and Pₙ, respectively. The shortest length LAₜ of non-facing portion Pₜ provided on each first electrode D1 and the shortest length LAₙ of non-facing portion Pₙ satisfy LAₜ<LAₙ in a horizontal state.

The shortest length LAₜ of non-facing portion Pₜ may be the same or may be different in all first electrodes D1. Similarly, shortest length LAₙ of non-facing portion Pₙ may be the same or may be different in all first electrodes D1. An embodiment in which LAₙ is different is shown in a third exemplary embodiment.

Also in this case, even when the vicinity of S1ₜ of electrode group 10 is fixed and the S1ₙ side is pulled downward (or upward) in the drawing sheet so as to bend electrode group 10, the entire surfaces of second active material layers A2 on both main surfaces of second electrode D2 can face any of first active material layers A1 of first electrodes D1 adjacent to second electrode D2.

### Third Exemplary Embodiment

This exemplary embodiment is the same as the second exemplary embodiment except that the size of second active material layer A2 of second electrode 3 (D2) is changed (see FIG. 5). As shown in FIG. 5, when the vicinity of S1ₜ is fixed and the S1ₙ side is pulled downward in the drawing sheet, the size of second active material layer A2 of second electrode D2_{b} in the lower part in the drawing sheet (inner side of the bending), may be made smaller than the size of second active material layer A2 in the upper part (outer side of the bending). In this case, first active material layers A1 on both surfaces of first electrode D1ₘ in the middle have non-facing portions Pₙ having different lengths (LAₙ₁ and LAₙ₂ in FIG. 5) in a horizontal state. Thus, even when the degree of bending of the flexible battery is larger than that of the second exemplary embodiment, or when a thickness of the flexible battery is large, the entire surface of second active material layer A2 can be easily allowed to face first active material layers A1 adjacent to second active material layer A2. The lengths of non-facing portions Pₜ may be the same as each other or different from each other.

Hereinafter, detailed configuration in the case where the flexible battery in accordance with this exemplary embodiment is a lithium ion secondary battery is described.

### First Electrode

From the viewpoint of improving cycle characteristics, first electrode D1 is preferably a negative electrode.

The negative electrode includes a negative electrode current collector and a negative electrode active material layer. The negative electrode active material layer is formed on a part of the negative electrode current collector. Examples of the negative electrode current collector include metal materials such as a metal film, a metal foil, and non-woven fabric of metal fiber. The metal foil may be an electrolytic metal foil obtained by an electrolytic method or may be a rolled metal foil obtained by a rolling method. The electrolytic method has advantages in excellent mass productivity and relatively low manufacturing cost. On the other hand, the rolling method facilitates thinning, so that it is advantageous in achieving light weight. Among them, a rolled metal foil is preferable because it is crystalline-orientated along the rolling direction and has excellent bending resistance.

Examples of types of metal to be used for the negative electrode current collector include copper, nickel, magnesium, and stainless steel. These may be used singly or two or more thereof in combination. A thickness of negative electrode current collector 10 is preferably 5 to 30 μm, and more preferably 8 to 15 μm.

The negative electrode active material layer includes a negative electrode active material, and may be a material mixture layer including a binding agent or a conductive agent if necessary. The negative electrode active material is not particularly limited and can be appropriately selected from the well-known materials and compositions. Examples thereof include metallic lithium, a lithium alloy, carbon material (various types of natural and artificial graphite), silicide (silicon alloy), silicon oxide, a lithium-containing titanium compound (for example, lithium titanate), and the like.

Examples the conductive agent include graphite such as natural graphite and artificial graphite; carbon black such as acetylene black, Ketjen black, channel black, furnace black, lampblack, and thermal black. The amount of the conductive agent is, for example, 0 to 20 parts by mass relative to 100 parts by mass of the negative electrode active material.

Examples of the binding agent include a fluorocarbon resin including a vinylidene fluoride unit, for example, polyvinylidene fluoride (PVdF), a fluorocarbon resin which does not include a vinylidene fluoride unit, for example, polytetrafluoroethylene; an acrylic resin such as polyacrylonitrile and polyacrylic acid; and rubbers such as styrene-butadiene rubber. The amount of the binding agent is, for example, 0.5 to 15 parts by mass relative to 100 parts by mass of the negative electrode active material.

The thickness of the negative electrode active material layer is preferably, for example, 1 to 300 μm. When the thickness of the negative electrode active material layer is 1 μm or more, sufficient capacity can be kept. On the other hand, when the thickness of the negative electrode active material layer is 300 μm or less, the flexibility of the negative electrode is enhanced, and bending load to the current collector tends to be smaller. Note here that the negative electrode active material layer is formed only on one surface of the negative electrode current collector in the negative electrode disposed on the end portion (outermost layer) of the electrode group, and formed on both surfaces of the negative electrode current collector in the negative electrode disposed in the inner layer part. The negative electrode on the end portion is disposed such that a surface having the negative electrode active material layer faces the inside.

### Negative Electrode Lead Terminal

A material for a negative electrode lead terminal is not particularly limited as long as it is electrochemically and chemically stable and has conductivity, and it may be metal or nonmetal. Among them, a metal foil is preferable. Examples of the metal foil include a copper foil, a copper alloy foil, a nickel foil, a stainless steel foil, and the like. A thickness of the negative electrode lead terminal is preferably 25 to 200 μm and more preferably 50 to 100 μm.

### Second Electrode

Second electrode D2 is preferably a positive electrode. The positive electrode includes a positive electrode current collector and a positive electrode active material layer. The positive electrode active material layer is formed on a part of the positive electrode current collector. Examples of the positive electrode current collector include metal materials such as a metal film, a metal foil, and non-woven fabric of metal fiber. Examples of types of metal used include silver, nickel, titanium, gold, platinum, aluminum, stainless steel, and the like. These may be used singly, or in combination of two or more thereof. The thickness of the positive electrode current collector is preferably 5 to 30 μm, and more preferably 8 to 15 μm.

The positive electrode active material layer includes a positive electrode active material, and may be a material mixture layer including a binding agent or a conductive agent if necessary. The positive electrode active material is not particularly limited. Examples thereof include lithium-containing composite oxide, for example, LixₐCoO₂, LiₓₐNiO₂, LiₓₐMnO₂, LiₓₐCo_{y}Ni_{1-y}O₂, LiₓₐCO_{y}M_{1-y}O_{z}, LiₓₐNi_{1-y}M_{y}O_{z}, Li_{xb}Mn₂O₄, Li_{xb}Mn_{2-y}M_{y}O₄, or the like. Herein, M is at least one element selected from the group consisting of Na, Mg, Sc, Y, Mn, Fe, Co, Ni, Cu, Zn, Al, Cr, Pb, Sb, and B; and xa=0 to 1.2; xb=0 to 2; y=0 to 0.9; and z=2 to 2.3, are satisfied. The values xa and xb increase and decrease by charge and discharge.

Examples of the binding agent and the conductive agent can include materials given as the examples of the negative electrode. Furthermore, these blending amounts are similar to those of the negative electrode.

The thickness of the positive electrode active material layer is preferably, for example, 1 to 300 μm. When the thickness of the positive electrode active material layer is 1 μm or more, sufficient capacity can be kept. On the other hand, when the thickness of the positive electrode active material layer is 300 μm or less, the flexibility of the positive electrode is enhanced, and bending load to the current collector tends to be smaller. Note here that the positive electrode active material layer is formed only on one surface of the positive electrode current collector forming the positive electrode on the end portion when the positive electrode is disposed on the end portion (outermost layer) of the electrode group. The positive electrode active material layer is formed on both surfaces of the positive electrode current collector in the positive electrode disposed in the inner part. The positive electrode on the end portion is disposed such that a surface having the positive electrode active material layer faces the inside.

### Positive Electrode Lead Terminal

A material for a positive electrode lead terminal is not particularly limited as long as it is electrochemically and chemically stable and has conductivity, and it may be metal or nonmetal. Among them, a metal foil is preferable. Examples of the metal foil include an aluminum foil, an aluminum alloy foil, a stainless steel foil, and the like. A thickness of the positive electrode lead terminal is preferably 25 to 200 μm and more preferably 50 to 100 μm.

### Electrolyte Layer

The electrolyte layer is not particularly limited. Examples of thereof include a dry polymer electrolyte obtained by allowing a polymer matrix to contain electrolyte salt, a gel polymer electrolyte obtained by impregnating the polymer matrix with a solvent and an electrolyte salt, an inorganic solid electrolyte, and a liquid electrolyte (electrolytic solution) obtained by dissolving an electrolyte salt in a solvent, or the like.

A material to be used for the polymer matrix (matrix polymer) is not particularly limited, and, for example, a material capable of absorbing a liquid electrolyte to be gelled can be used. Specifically, a fluorocarbon resin including a vinylidene fluoride unit, an acrylic resin including (meth)acrylic acid and/or (meth)acrylic acid ester unit, and a polyether resin including a polyalkylene oxide unit, and the like. Examples of the fluorocarbon resin including a vinylidene fluoride unit include polyvinylidene fluoride (PVdF), a copolymer containing a vinylidene fluoride (VdF) unit and a hexafluoropropylene (HFP) unit (PVdF-HFP), and a copolymer containing a vinylidene fluoride (VdF) unit and a trifluoroethylene (TFE) unit, and the like. It is preferable that the amount of vinylidene fluoride unit contained in the fluorocarbon resin including a vinylidene fluoride unit is 1 mol % or more such that the fluorocarbon resin is easily swollen with the liquid electrolyte.

Examples of the electrolyte salt include LiPF₆, LiClO₄, LiBF₄, LiCF₃SO₃, LiCF₃CO₂, and imide salts. Examples of the solvent include nonaqueous solvents including cyclic carbonic acid ester such as propylene carbonate (PC), ethylene carbonate (EC), and butylene carbonate; chain carbonic acid ester such as diethyl carbonate (DEC), ethyl methyl carbonate, and dimethyl carbonate; cyclic carboxylic acid ester such as γ-butyrolactone and γ-valerolactone; dimethoxyethane; and the like. The inorganic solid electrolyte is not particularly limited, and an inorganic material having ionic conductivity can be used.

### Separator

An electrolyte layer may include a separator for preventing short circuits. Materials for the separator are not particularly limited, and include a porous sheet having predetermined ionic permeability, mechanical strength, and insulating property. Preferable examples thereof include polyolefin such as polyethylene and polypropylene; polyamides such as polyamide and polyamide-imide; a porous film or non-woven fabric of, for example, cellulose, or the like. The thickness of the separator is, for example, 8 to 30 μm.

### Housing

The housing is not particularly limited. The housing is preferably made of a film material having low gas permeability, and high flexibility. Specific examples thereof include a laminated film including a resin layer on both surfaces or one surface of a barrier layer. From the viewpoint of strength, gas barrier performance, and bending rigidity, it is preferable that the barrier layer includes metal materials such as aluminum, nickel, stainless steel, titanium, iron, platinum, gold, and silver; inorganic material (ceramics material) such as silicon oxide, magnesium oxide, aluminum oxide, or the like. From the same viewpoint, the thickness of the barrier layer is preferably 5 to 50 μm.

The resin layer may be a stack of two or more layers. In view of easiness of thermal welding, electrolyte resistance, and chemical resistance, material for the resin layer (seal layer) disposed on the inner surface side of the housing is preferably polyolefin such as polyethylene (PE) and polypropylene (PP); polyethyleneterephthalate, polyamide, polyurethane, polyethylene-vinyl acetate (EVA) copolymer, or the like. It is preferable that the thickness of the resin layer (seal layer) on the inner surface side is 10 to 100 μm. In view of strength, shock resistance, and chemical resistance, the resin layer (protective layer) disposed on the outer surface side of the housing is preferably polyamide (PA) such as 6,6-nylon; polyolefin; and polyester such as polyethylene terephthalate (PET), and polybutylene terephthalate, or the like. It is preferable that the thickness of the resin layer (protective layer) on the outer surface side is 5 to 100 μm.

Specifically, examples of the housing include a PE/Al layer/PE laminated film; an acid-modified PP/PET/Al layer/PET laminated film; an acid-modified PE/PA/Al layer/PET laminated film; an ionomer resin/Ni layer/PE/PET laminated film; an ethylene-vinyl acetate/PE/Al layer/PET laminated film; an ionomer resin/PET/Al layer/PET laminated film, and the like. Herein, in place of the Al layer, an inorganic compound layer such as an Al₂O₃ layer and a SiO₂ layer may be used.

The flexible battery of the present invention can be produced, for example, in the following manner. Herein, the case where the first electrode is a negative electrode of a lithium ion secondary battery, and the second electrode is a positive electrode of a lithium ion secondary battery is described.

### [Production of Negative Electrode]

A negative electrode active material, a conductive agent, a binding agent are mixed with each other to prepare a negative electrode material mixture. This negative electrode material mixture is dispersed in a solvent such as N-methyl-2-pyrrolidone (NMP) to prepare negative electrode material mixture slurry. Next, this negative electrode material mixture slurry is applied to one surface or both surfaces of the negative electrode current collector. At this time, the negative electrode material mixture slurry may be applied to only a part of the negative electrode current collector, so that a portion to which the negative electrode material mixture slurry is not applied (for example, a lead tab) may be formed. Then, the solvent is dried, followed by compression molding the resultant product by, for example, a roll pressing machine so as to produce a negative electrode. When the negative electrode active material layer is a metallic lithium and/or a lithium alloy, the foil thereof may be press-fitted to the negative electrode current collector to produce a negative electrode.

A first end of the negative electrode lead terminal is joined to the produced negative electrode. The negative electrode lead terminal can be joined to, for example, a lead tab that is formed on a negative electrode by various welding methods.

An area of the negative electrode active material layer to be formed on the negative electrode may be different for each negative electrode. The area of the negative electrode active material layer can be changed by appropriately changing an area of the negative electrode current collector to which the negative electrode material mixture slurry is to be applied. When the negative electrode active material layer is a metallic lithium and/or a lithium alloy, the area of the negative electrode active material layer can be changed by appropriately changing the size of the foil.

### [Production of Positive Electrode]

A positive electrode active material, a conductive agent, a binding agent are mixed with each other to prepare a positive electrode material mixture. This positive electrode material mixture is dispersed in a solvent such as NMP to prepare positive electrode material mixture slurry. Next, this positive electrode material mixture slurry is applied to one surface or both surfaces of the positive electrode current collector. At this time, the positive electrode material mixture slurry may be applied to only a part of the positive electrode current collector, so that a portion to which the positive electrode material mixture slurry is not applied (for example, a lead tab) may be formed. The solvent is dried, followed by compression molding the resultant product by, for example, a roll pressing machine so as to produce a positive electrode.

A first end of the positive electrode lead terminal is joined to the produced positive electrode. The positive electrode lead terminal can be joined to a lead tab that is formed on, for example, a second electrode by various welding methods as in the case of the first electrode.

An area of the positive electrode active material layer to be formed on the positive electrode may be different for each positive electrode or for each main surface of the positive electrode. The area of the positive electrode active material layer can be changed by appropriately changing an area of the positive electrode current collector to which the positive electrode material mixture slurry is to be applied.

### [Production of Electrolyte Layer]

An electrolyte layer can be formed by, for example, a method of mixing inorganic solid electrolyte powder with a binder, applying the resultant mixture to a film, followed by peeling thereof; a method of forming a deposited film of inorganic solid electrolyte into a film, and then peeling thereof; a method of impregnating a separator with a polymer matrix, a solvent and electrolyte salt; a method of impregnating a separator with a solvent and electrolyte salt (electrolytic solution), and the like. Impregnation of a separator with a solvent and electrolyte salt may be carried out after an electrode group is inserted into a housing.

### [Production of Electrode Group]

The produced positive electrode and negative electrode are stacked to each other with the electrolyte layer interposed therebetween to produce an electrode group. At this time, the negative electrode (first electrode D1) and the positive electrode (second electrode D2) are stacked to each other such that LAₜ<LAₙ is satisfied.

### [Sealing]

An electrode group is housed in a housing such that second ends of the positive electrode lead terminal and the negative electrode lead terminal can be pulled out to the outside of the housing, respectively. Then, sealing is carried out by heat-sealing predetermined sections by, for example, hot plate under reduced pressure. At this time, heat sealing by, for example, hot plate with one side of the housing left, thereby forming a bag-type housing. From an opening of the bag-type housing, an electrolytic solution (solvent and/or electrolyte salt) is filled, and then, remaining side may be sealed under reduced pressure. Thus, a flexible battery is produced.

### EXAMPLES

Hereinafter, the present invention is specifically described with reference to Examples. However, the present invention is not limited to these Examples.

### Example 1

A flexible battery having a structure of “negative electrode/positive electrode/negative electrode” was produced in the following procedures.

### (1) Production of Negative Electrode (First Electrode D1)

One-hundred parts by mass of graphite having an average particle diameter of 22 μm (negative electrode active material), 8 parts by mass of VdF-HFP copolymer (content of VdF unit: 5 mol %, a binding agent), and an appropriate amount of NMP were mixed with each other to obtain a paste-like negative electrode material mixture.

A copper foil (negative electrode current collector, thickness 8 μm) was cut into two pieces each having a rectangular main part (long side: 47 mm, short side: 18 mm), and lead tabs extending from one short side of the main part. The paste-like negative electrode material mixture was applied to a main part of one surface of each of the obtained cut pieces, followed by drying at 85° C. for 10 minutes and compressing by using a roll pressing machine. Thus, two negative electrodes D1 (first electrodes D1) each having a negative electrode active material layer (thickness: 100 μm) on one surface of the main part were produced.

Then, in one of the produced negative electrodes D1, a first end of a negative electrode lead terminal (width: 1.5 mm, thickness: 50 μm) made of nickel was ultrasonically welded to a lead tab on the surface on which a negative electrode active material layer had not been formed.

### (2) Production of Positive Electrode (Second Electrode D2)

LiCoO₂ (positive electrode active material) having an average particle diameter of 20 μm, acetylene black (conductive agent), and PVdF (binding agent) were mixed with each other in a mass ratio of LiCoO₂ acetylene black:PVdF of 100:2:2 in NMP, and then, an appropriate amount of NMP was further added to the mixture so as to adjust the viscosity. Thus, a paste-like positive electrode material mixture was obtained.

The paste-like positive electrode material mixture was applied to both surfaces of an aluminum foil (positive electrode current collector, thickness: 15 μm). The resultant product was dried at 85° C. for 10 minutes, then compressed by using a roll pressing machine to form a positive electrode active material layers (thickness: 50 μm each) on both surfaces of the positive electrode current collector. The positive electrode current collector having a positive electrode active material layer on both surfaces of the main part was cut into a rectangular main part (long side: 45 mm, short side: 16 mm) and a lead tab extending from one of the short sides of the main part, followed by drying under reduced pressure at 120° C. for two hours. Then, the positive electrode active material layers, which had been formed on both surfaces of the lead tab part, were peeled off to produce positive electrode D2 having the positive electrode active material layers on both surfaces thereof. Next, the first end of the positive electrode lead terminal (width: 3 mm, thickness: 50 μm) made of aluminum was ultrasonically welded to one of the surfaces of the lead tab.

### (3) Production of Electrolyte Layer

LiPF₆ (electrolyte salt) was dissolved in a nonaqueous solvent obtained by mixing EC, PC, and DEC in the ratio of EC:PC:DEC=40:5:55 (volume ratio) so that the concentration was 1 mol/L to prepare a liquid electrolyte.

A copolymer of HFP and VdF (HFP content: 7 mol %) was used as a matrix polymer. The matrix polymer and the liquid electrolyte were mixed with each other in a ratio of 1:10 (mass ratio). Then, DMC as a solvent was used to prepare a gel polymer electrolyte solution.

The resultant gel polymer electrolyte solution was uniformly applied to both surfaces of a 9 μm-thick separator made of porous polyethylene, and the solvent was volatilized, thereby impregnating the separator with the gel polymer electrolyte. Thus, an electrolyte layer (long side: 50 mm, short side: 20 mm) was produced.

### (4) Production of Electrode Group

The produced two negative electrodes D1 and positive electrode D2 were stacked to each other such that LAₜ was 0.5 mm and LAₙ was 1.5 mm (see FIG. 2). Then, lead tabs of the two negative electrodes were electrically joined to each other by ultrasonic welding. Thereafter, the stack was hot pressed at 90° C. and 1.0 MPa for 30 seconds to produce an electrode group (thickness: 350 μm).

### (5) Sealing

An aluminum foil (thickness: 20 μm) as a barrier layer was provided with a PE film (thickness: 30 μm) as a seal layer on one surface, and a nylon film as a protective layer (thickness: 20 μm) on the other surface. Thus, a film material (nylon protective layer/Al layer/PE seal layer) was prepared. The film material was molded into a bag-type housing having a size of 60 mm×25 mm. Then, an electrode group was inserted from an opening of the housing such that second ends of the positive electrode lead terminal and the negative electrode lead terminal extend to the outside from the opening of the housing. The housing into which the electrode group was inserted was placed in atmosphere whose pressure was adjusted to 660 mmHg, and the opening was heat-sealed in this atmosphere. Thus, a flexible battery having a size of 60 mm in long side×25 mm in short side×0.49 mm in thickness was produced.

### Example 21

A flexible battery (thickness: 0.84 mm) having a structure of “negative electrode/positive electrode/negative electrode (D1ₘ)/positive electrode/negative electrode” as shown in FIG. 4 was produced in the same manner as in Example 1 except that two negative electrodes D1 and two positive electrodes D2 produced in the same manner as in Example 1, and negative electrode D1ₘ having negative electrode active material layers (each thickness: 100 μm) on both surfaces thereof were used.

### Example 3

A flexible battery having a structure of “negative electrode/positive electrode/negative electrode/positive electrode/negative electrode” as shown in FIG. 4 was produced in the same manner as in Example 1 except that three negative electrodes (D1 (two electrodes) and D1ₘ) produced in the same manner as in Example 2, and two positive electrodes D2 produced as mentioned below were used. Note here that LAₜ was 0.8 mm and LAₙ was 1.2 mm

### Production of Positive Electrode D2

Two positive electrodes D2 each having a positive electrode active material layer having the same size on both surfaces thereof were produced in the same manner as in Example 1 except that the main part of the positive electrode current collector had a size of 42 mm in long side×16 mm in short side.

### Example 4

A flexible battery having a structure of “negative electrode/positive electrode/negative electrode (D1ₘ)/positive electrode (D2_{b})/negative electrode” as shown in FIG. 5 was produced in the same manner as in Example 1 except that two negative electrodes D1 and two positive electrodes D2 produced in the same manner as in Example 1, negative electrode D1ₘ produced in the same manner as in Example 2, and positive electrode D2_{b} produced as mentioned below were used. Note here that LAₜ was 0.5 mm, LAₙ₁ was 1.5 mm, and LAₙ₂ was 2.5 mm

### Production of Positive Electrode D2_{b}

Positive electrodes D2_{b} having positive electrode active material layers having the same size on both surfaces thereof were produced in the same manner as in Example 1 except that the main part of the positive electrode current collector had a size of 44 mm in long side×16 mm in short side.

### Comparative Example 1

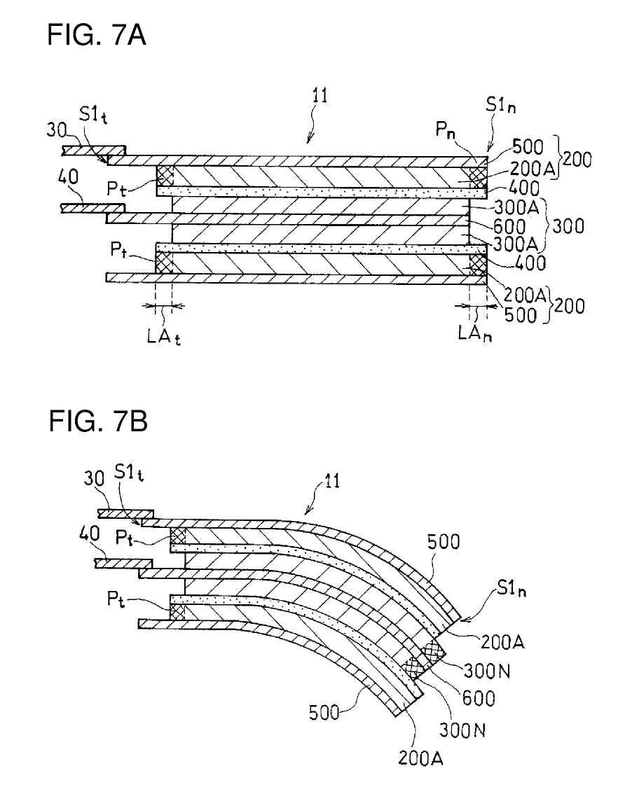

A flexible battery having a structure of “negative electrode/positive electrode/negative electrode” as shown in FIG. 7 was produced in the same manner as in Example 1 except that a length of the long side of the positive electrode current collector was 46 mm Note here that both LAₜ and LAₙ₁ were 0.5 mm.

### [Initial Discharge Capacity]

The produced flexible battery was subjected to the following charge and discharge at ambient temperature of 25° C., and the initial capacity in a horizontal state was obtained. Herein, the design capacity of the flexible battery is defined as 1 C (mAh).

(1) Constant current charge: 0.7 CmA (final voltage: 4.2 V)
(2) Constant voltage charge: 4.2 V (final current: 0.05 CmA)
(3) Constant current discharge: 0.2 CmA (final voltage: 3 V)

### [Discharge Capacity Retention Rate]

The produced flexible battery was subjected to 500 charge/discharge cycles in a bending state mentioned below. One cycle includes the above-mentioned charge and discharge (1) to (3). After 500 cycles, discharge capacity was measured in the horizontal state in the same conditions as mentioned above. The discharge capacity retention rate was calculated from the following mathematical formula:

(Discharge capacity after 500 cycles/Initial discharge capacity)×100(%).

The capacity retention rate was calculated as an average value of values of 10 cells for each battery. Results are shown in Table 1.

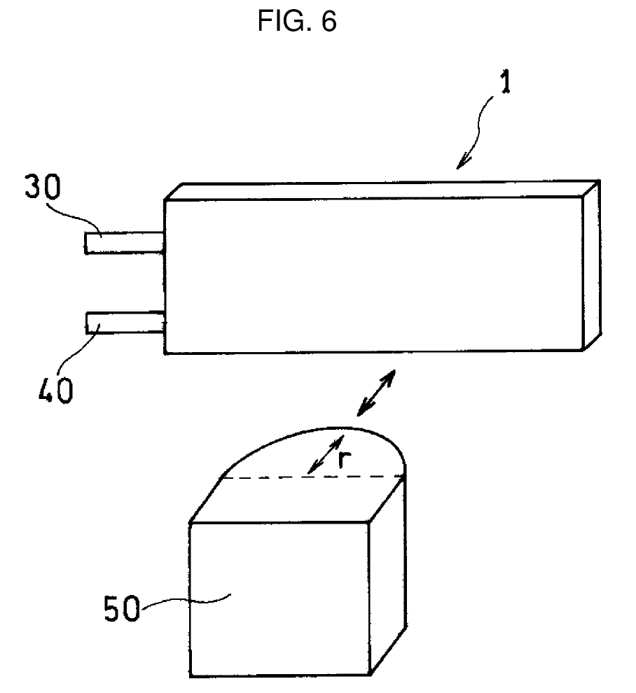

The above-mentioned bending state is described with reference to FIG. 6.

A side corresponding to side S1ₜ from which the electrode lead terminals of flexible battery 1 were led out and a side facing the side were fixed by a pair of jigs, respectively. Then, jig 50 for a bending test was pressed onto the fixed flexible battery 1. Jig 50 has radius of curvature r at the tip end surface thereof of 30 mm Note here that in the flexible battery produced in Example 4, jig 50 was pressed from positive electrode D2_{b}. Subsequently, flexible battery 1 was bent until the radius of curvature of flexible battery 1 uniformly became 30 mm that is the same as the radius of curvature r of jig 50 (bending state). In this bending state, the above-mentioned charge/discharge cycles were carried out. Finally, jig 50 was separated from flexible battery 1, and shape was recovered from the deformed shape until flexible battery 1 became the original flat shape (horizontal state). Discharge capacity in this state was measured again.

Note here that in Example 1 and Comparative Example 1, the average bending radius of the main surface at the bending side of the positive electrode active material layer on the innermost side of bending was about 30.2 mm. In Example 2 to 4, the average bending radius of the main surface disposed at the bending side of the positive electrode active material layer on the innermost side of bending was about 30.2 mm; and the average bending radius of the main surface disposed at the bending side of the positive electrode active material layer on the outermost side of bending was about 30.6 mm

TABLE 1

| | | | | | Comparative |
|---|---|---|---|---|---|
| | Examples | | | | Example |
| | 1 | 2 | 3 | 4 | 1 |
| LAₜ | 0.5 mm | 0.5 mm | 0.8 mm | 0.5 mm | 0.5 mm |
| LAₙ | 1.5 mm | 1.5 mm | 1.2 mm | LAₙ₁: 1.5 mm | 0.5 mm |
| | | | | LAₙ₂: 2.5 mm | |
| Capacity | 95% | 92% | 84% | 91% | 57% |
| retention | | | | | |
| rate | | | | | |

Examples 1 to 4 satisfying LAₜ<LAₙ showed high capacity retention rate. Among them, Examples 1, 2, and 4 satisfying 2LAₜ<LAₙ are particularly excellent in the capacity retention rate.

### INDUSTRIAL APPLICABILITY

A flexible battery of the present invention can be mounted to various electronic devices. The electronic devices are not necessarily limited to electron paper, an IC tag, a multifunctional card, and an electron key, and also include, for example, a biological information measuring device and an iontophoretic dermal administration device. In particular, the flexible battery of the present invention is used for electronic devices having flexibility, specifically, for electronic devices that require high cycle characteristics with respect to a battery incorporated.

### REFERENCE MARKS IN THE DRAWINGS

1 flexible battery
2 first electrode (D1)
3 second electrode (D2)
4 electrolyte layer
5 first current collector
6 second current collector
10, 11 electrode group
20 housing
30, 40 electrode lead terminal
50 jig
200 negative electrode
200A negative electrode active material layer
300 positive electrode
300A positive electrode active material layer
400 electrolyte layer
500 negative electrode current collector
600 positive electrode current collector

1. A flexible battery comprising:
a sheet-like electrode group including first electrode D1, second electrode D2, and an electrolyte layer interposed between the first electrode D1 and the second electrode D2;
a pair of electrode lead terminals connected to the first electrode D1 and the second electrode D2, respectively; and
a housing for housing the electrode group,
wherein
the first electrode D1 and the second electrode D2 are all rectangular,
first ends of the electrode lead terminals are connected to the first electrode D1 and the second electrode D2, respectively, on a side S1t side of the electrode group,
the first electrode D1 includes a first current collector, and a first active material layer A1 formed on a surface of the first current collector,
the second electrode D2 includes a second current collector, and a second active material layer A2 formed on a surface of the second current collector,
the first active material layer A1 on at least one main surface of the first electrode D1 has a non-facing portion Pt with respect to the second active material layer A2 on one surface of the second electrode D2 on the S1t side, and a non-facing portion Pn with respect to the second active material layer A2 on one main surface of the second electrode D2 on an opposite side to the S1t, and
a shortest length LAt of the non-facing portion Pt in a direction perpendicular to the S1t and a shortest length LAn of the non-facing portion Pn in a direction perpendicular to the S1t satisfy LAt<LAn in a horizontal state.

2. The flexible battery of claim 1, wherein the LAt and the LAn satisfy 2LAt<LAn in a horizontal state.

3. The flexible battery of claim 1, wherein, in a horizontal state, the LAn is larger than ½ of a total of a thickness TD1 of the first active material layer A1, a thickness TD2 of a second active material layer A2 adjacent to the first active material layer A1, a thickness TE of the electrolyte layer interposed between the first active material layer A1 and the second active material layer A2.

4. The flexible battery of claim 1, wherein, in a horizontal state, the LAn is larger than 1/50 of length LA2 of the second active material layer A2 in the direction perpendicular to the S1t.

5. The flexible battery of claim 1, wherein the flexible battery is used in a state in which the second active material layer A2 is bent at an average radius of curvature r satisfying 15 mm≦r≦100 mm.
